(19) United States
(12) Patent Application Publication
(10) Pub. No.: US 2012/0090975 A1
(43) Pub. Date: Apr. 19, 2012

(54) SWITCHING DEVICE

(75) Inventor: Roman Kolm, Schweiggers (AT)

(73) Assignee: Eaton GmbH, Schrems (AT)

(21) Appl. No.: 13/087,911

(22) Filed: Apr. 15, 2011

Related U.S. Application Data
(60) Provisional application No. 61/324,894, filed on Apr. 16, 2010.

(30) Foreign Application Priority Data
Apr. 16, 2010 (AT) A 626/2010

(51) Int. Cl. H01H 13/70

(52) U.S. Cl. 200/5 R

(57) ABSTRACT

To increase safety when working on electrical installations, a switching device which has a first switch position and a second switch position, includes a first movable switch contact contacting a first contact part in the first switch position and a third contact part in the second switch position, and a second movable switch contact contacting a second contact part in the first switch position and a fourth contact part in the second switch position, wherein the third contact part and the fourth contact part are conductively connected with one another. The switching device can be constructed as a ground-fault circuit interrupter and/or a line circuit breaker.

### CROSS-REFERENCES TO RELATED APPLICATIONS

This application claims the benefit of prior filed U.S. provisional Application No. 61/324,894, filed Apr. 16, 2010, pursuant to 35 U.S.C. 119(e), the content of which is incorporated herein by reference in its entirety as if fully set forth herein.

This application also claims the priority of Austrian Patent Application, Serial No. A 626/2010, filed Apr. 16, 2010, pursuant to 35 U.S.C. 119(a)-(d), the content of which is incorporated herein by reference in its entirety as if fully set forth herein.

### BACKGROUND OF THE INVENTION

The present invention relates to a switching device.

The following discussion of related art is provided to assist the reader in understanding the advantages of the invention, and is not to be construed as an admission that this related art is prior art to this invention.

When working in and on electrical facilities, specific rules apply to prevent electrical accidents, which are summarized in the so-called “five safety rules” listed hereafter, and which are to be applied by the respective technicians:
1. Disconnect facility from power.
2. Secure facility against reconnection.
3. Establish facility is unpowered.
4. Ground and short-circuit facility.
5. Cover or prevent access to adjacent parts which are powered.

These five safety rules are to be applied in the above-mentioned sequence before working on electrical facilities. After work is completed, they are to be canceled again in the reverse sequence. These rules are presumed to be known by every electrician, however, it has been shown that electricians often presume that—after the power supply is interrupted—life-threatening voltages/currents no longer occur in the facility without the power supply, because of which number 3: “establish device is unpowered” is typically often ignored by electricians. Furthermore, disconnected low-voltage facilities are rarely grounded and short-circuited in practice. However, since manifold power storage means may be integrated in electrical facilities, in particular capacitive or inductive power storage means, such as capacitors or coils (motor windings, transformers), the danger also exists in disconnected electrical facilities that hazardous currents could occur—through discharge of the affected power storage means.

It would therefore be desirable and advantageous to obviate prior art shortcomings and to provide an improved to switching device with which the safety when working on electrical facilities can readily be increased.

### SUMMARY OF THE INVENTION

According to one aspect of the present invention, a switching device has a first switch position and a second switch position; the switching device includes a first movable switch contact contacting a first contact part in the first switch position and a third contact part in the second switch position, and a second movable switch contact contacting a second contact part in the first switch position and a fourth contact part in the second switch position. The third contact part and the fourth contact part are conductively connected.

This can reliably prevent electrical power which is stored in charged capacitive or inductive components from becoming a hazard to a worker when working on disconnected electrical facilities, for example, electrical power distribution networks. The hazard of an electrical shock in such electrical facilities is thus significantly reduced, in particular prevented. A hazardous state in electrical facilities by discharge of inductively or capacitively stored electrical power via a human body can thus be prevented.

The facility-side parts of the affected disconnected subnetwork are therefore short-circuited, whereby discharge of electrical power storage elements occurs. Through the advantageous integration of the function of the short-circuiting of the facility-side parts of the subnetwork in a switching device, in particular a ground-fault circuit interrupter, line circuit breaker, circuit breaker, master switch, or the like, the short-circuiting of the facility is already performed in the course of the disconnection of the affected facility. The affected electrician therefore cannot forget to short-circuit the facility.

Additional advantageous embodiments of the present invention may include one or more of the following features.

According to one advantageous feature of the present invention, the first and the second movable switch contacts may be mechanically coupled with one another, for example via a common switch shaft. Advantageously, the switching device may include a housing, wherein the first, second, third and fourth contact parts are secured against displacement in the housing.

According to one advantageous feature of the present invention, the third contact part and the fourth contact part may be conductively connected via at least one first switch or a button, or a combination thereof.

According to one advantageous feature of the present invention, the third contact part and the fourth contact part may be conductively connected to a grounding terminal. The third contact part may hereby be conductively connected to the grounding terminal via a second switch, and the fourth contact part may be conductively connected to the grounding terminal via a third switch.

According to one advantageous feature of the present invention, the switching device may have a third switch position, in which third position the first movable switch contact and the second movable switch contact are each held in a contact-free position. The contact-free position may be a locked position.

According to one advantageous feature of the present invention, the at least one first switch or button, the second switch and third switch may be configured for actuation independent of the switch position of the first and second movable switch contacts.

The switching device may be implemented as a ground-fault circuit interrupter or as a line circuit breaker.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a schematic diagram of a first embodiment of a switching device according to the present invention;

FIG. 2 shows a schematic diagram of a second embodiment of a switching device according to the present invention;

FIG. 3 shows a schematic diagram of a third embodiment of a switching device according to the present invention; and

FIG. 4 shows a schematic diagram of a fourth embodiment of a switching device according to the present invention.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

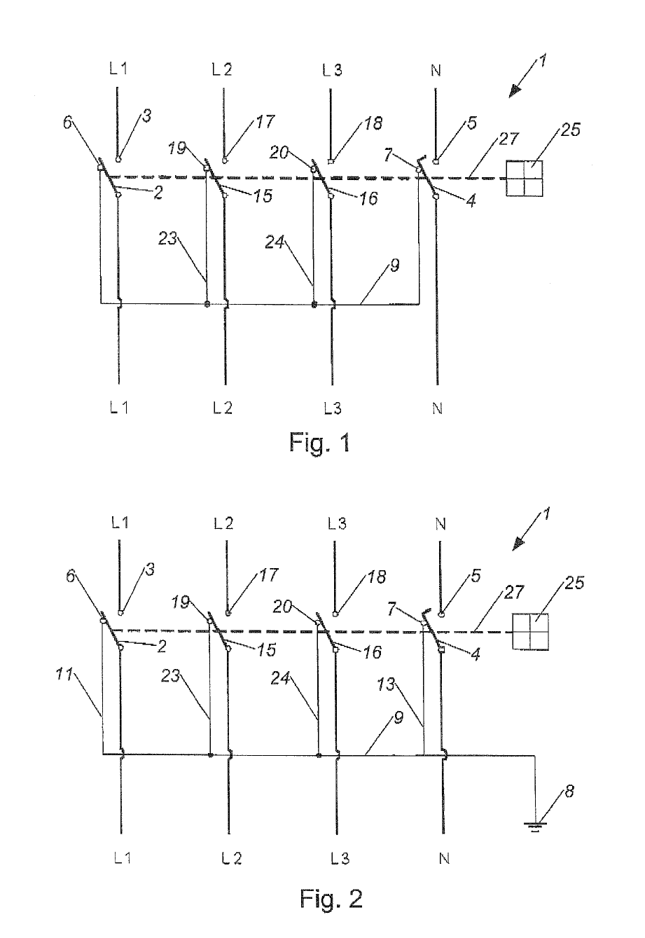

Turning now to the drawing, FIGS. 1 to 4 show schematic views of advantageous embodiments of a switching device 1 having a first movable switch contact 2, which presses against a first contact part 3 in a first switch position, and having a second movable switch contact 4, which presses against a second contact part 5 in the first switch position, in a second switch position, the first movable switch contact 2 pressing against a third contact part 6 and the second movable switch contact 4 pressing against a fourth contact part 7, and the third contact part 6 and the fourth contact part 7 being conductively connected.

The safety when working on electrical facilities can thus be readily increased. Electrical power which is stored in charged capacitive or inductive components can thus be reliably prevented from becoming a hazard to a worker when working on disconnected electrical facilities, for example, electrical power distribution networks. The hazard of an electrical shock in such electrical facilities is thus significantly reduced, in particular prevented. A hazardous state in electrical plants by discharging inductively or capacitively stored electrical power via a human body can thus be prevented.

The facility-side parts of the affected disconnected subnetwork are thus short-circuited, whereby discharge of electrical power storage elements occurs. Through the advantageous integration of the function of the short-circuiting of the facility-side parts of the subnetwork in a switching device, in particular a ground-fault circuit interrupter, line circuit breaker, circuit breaker, master switch, or the like, the short-circuiting of the facility is already performed in the course of the disconnection of the affected facility. The affected electrician therefore cannot forget to short-circuit the facility.

Switching devices 1 according to the invention are preferably located in a circuit between an electrical power distribution and/or supply network and an electrical subnetwork, in order to disconnect the affected subnetwork from the power distribution and/or supply network—for example, in case of fault. Furthermore, such switching devices 1 are implemented for the purpose of manually disconnecting the subnetwork from the power distribution and/or supply network in a predefinable way. A power distribution and/or supply network can preferably be any type of an electrical network. It is preferably provided that the affected electrical network has at least one first conductor L1 and one second conductor N. Any number of conductors can be provided, it being particularly preferable as shown to further provide a third conductor L2 and a fourth conductor L3 to protect a typical three-phase current network, in addition to the mentioned first and second conductors L1, N.

Switching devices 1 according to the invention typically have connection terminals, in particular screw connection terminals or plug connection terminals, for connecting the electrical conductors L1, L2, L3, N of the electrical network. The switching device 1 has two connection terminals per electrical conductor L1, L2, L3, N in each case. A contact gap, in which at least one movable switch contact 2, 4, 15, 16 is located, is implemented between two connection terminals, which are associated with an electrical conductor L1, L2, L3, N, in the switching device 1. In a first switch position, the respective movable switch contact 2, 4, 15, 16 presses against a contact part 3, 17, 18, 5 associated therewith, whereby the contact gap is closed by the switching device 1.

Switching devices 1 according to the invention are preferably implemented as ground-fault circuit interrupters, line circuit breakers, circuit breakers, and/or master switches, at least one trigger mechanism being able to be provided to control the switch position of the movable switch contacts 2, 4, 15, 16 in a predefinable way or as a function of the state of the electrical network. Such a switching device 1 can be remotely switched, for example, or have a trigger mechanism, which responds to fault currents, overvoltages, and/or overcurrents, and which causes the transfer of the movable switch contacts 2, 4, 15, 16 from the first switch position into the second switch position. Switching devices 1 according to the invention preferably further have a breaker latching mechanism 25 for triggering the movable switch contacts 2, 4, 15, 16, and a manual actuation lever, for manually moving the movable switch contacts 2, 4, 15, 16 from the first switch position into the second switch position. It is preferably provided that the first and the second movable switch contacts 2, 4 are mechanically coupled, in particular are located on a common switch shaft 27. This preferably provided switch shaft 27 is shown in FIGS. 1 to 4 by a dashed line.

The components of a switching device 1 according to the invention are preferably located in a housing made from an insulating material, in which housing the first, second, third, and fourth contact parts 3, 5, 6, 7, and, if provided, also the further contact parts 17, 18, 19, 20 are located secured against displacement. It can also be provided that in addition to the first, second, third, and fourth movable switch contacts 2, 4, 15, 16 according to the present description, contact parts can also be implemented as movable.

The illustrated advantageous embodiments of a switching device 1 according to the invention each have a first movable switch contact 2, which presses against a first contact part 3 in a first switch position, a second movable switch contact 4, which presses against a second contact part 5 in the first switch position, a third movable switch contact 15, which presses against a fifth contact parts 17 in the first switch position, and a fourth movable switch contact 16, which presses against a sixth contact part 18 in the first switch position. The movable switch contacts 2, 4, 15, 16 are provided and implemented for the predefinable interruption of at least one of the conductors L1, L2, L3, N of an electrical network to be protected.

It is provided according to the invention that in a second switch position, the first movable switch contact 2 presses against a third contact part 6 and the second movable switch contact 4 presses against a fourth contact part 7, and furthermore that the third contact part 6 and the fourth contact part 7 are conductively connected, whereby the above-described advantageous effects can be achieved. According to the illustrated advantageous embodiments, it is further provided that the third movable switch contact 15 presses against a seventh contact part 19 and the fourth movable switch contact 16 presses against an eighth contact part. 20, the third, fourth, seventh, and eighth contact parts 6, 7, 19, 20 also being conductively connected to one another, preferably all of them. FIG. 1 shows a schematic view of a switching device 1 implemented in such a way.

According to a preferred refinement of a switching device 1 according to the invention and according to the particularly preferred second implementation thereof shown in FIG. 2, it is provided that the third contact part 6 and the fourth contact part 7 are conductively connected to a grounding terminal 8. In addition to the short circuit of the facility-side lines of the network, grounding thereof is thus further provided. The safety during electrical work can thus be increased still further. As shown in FIG. 2, in the advantageous implementation of a switching device 1 according to the invention having four contact gaps, it is further provided that the seventh contact part 19 and the eighth contact part 20 are conductively connected to the grounding terminal 8. It can be provided that separate lines run from each of the contacts to the grounding terminal 8.

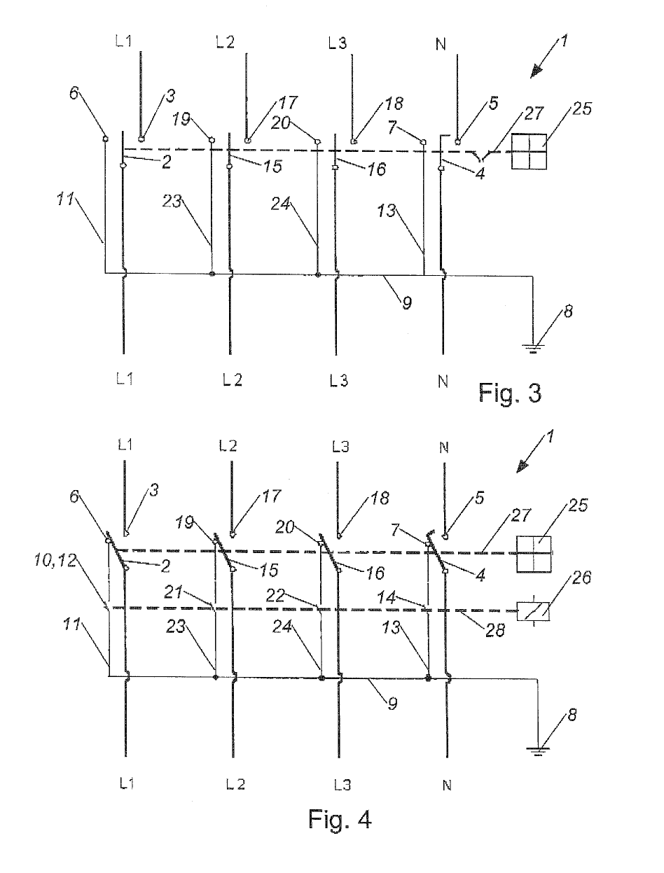

FIG. 3 shows a third advantageous embodiment of a switching device 1 according to the invention, the first movable switch contact 2 and the second movable switch contact 4 being located in a third switch position, in which third switch position the first and second movable switch contacts 2, 4 are held in a contact-free position, therefore, a position between the first and third or second and fourth contact parts 3, 5, 6, 7, respectively. According to FIG. 3, the third and the fourth movable switch contacts 15, 16 are further also located in the affected third switch position, therefore a contact-free position. In particular, it is provided that the switching device 1 further has means in order to at least temporarily lock the affected movable switch contacts 2, 4, 15, 16 in this third switch position. Through the possibility of the third switch position, the possibility exists of performing an isolation test on the conductors L1, L2, L3, N of an electrical network to be protected. After completed isolation measurement, the switching device 1 can be transferred into the first or second switch position.

In a refinement of a switching device 1 according to the invention, preferably as an alternative implementation to the third advantageous embodiment, it is preferably provided that at least one first switch 10 and/or button is located in a first connection line 9 between the third and the fourth contact parts 6, 7. In this way, in the case of switching devices 1 having only two contact gaps, the possibility is provided of an isolation test of the first and second conductors L1, N to one another, however, the contact apparatus of such a switching device 1 being able to be designed significantly more simply than in the case of a switching device 1 according to the third advantageous embodiment, since the third switch position is not required. The affected first line L1 can easily be interrupted by the first switch 10.

Furthermore, in a refinement of the invention, it is provided that a second switch 12 is located in a second connection line 11 between the third contact part 6 and the grounding terminal 8, and a third switch 14 is located in a third connection line 13 between the third contact part 6 and the grounding terminal 8. An isolation test can thus further be performed very easily between the first or second conductors L1, N and ground.

FIG. 4 shows such a fourth advantageous embodiment of a switching device 1 according to the invention. The first and the second switches 10, 12 are implemented in one piece. In addition to the third switch 14 shown, furthermore, a fourth connection line 23 having a fourth switch 21, and a fifth connection line 24 having a fifth switch 22 are shown.

It is preferably provided that the at least one first switch 10 and/or second switch 12 and/or third switch 14, and furthermore preferably the fourth switch 21 and the fifth switch 22 is/are operable, in particular manually, in a predefinable way and independently of the switch position of at least one of the first and/or second movable switch contacts 2, 4.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A switching device having a first switch position and a second switch position, the switching device comprising:
a first movable switch contact contacting a first contact part in the first switch position and a third contact part in the second switch position, and
a second movable switch contact contacting a second contact part in the first switch position and a fourth contact part in the second switch position,
wherein the third contact part and the fourth contact part are conductively connected.

2. The switching device of claim 1, wherein the third contact part and the fourth contact part are conductively connected to a grounding terminal.

3. The switching device of claim 1, the switching device further having a third switch position, wherein the first movable switch contact and the second movable switch contact are each held in a contact-free position.

4. The switching device of claim 3, wherein the contact-free position is a locked position.

5. The switching device of claim 1, wherein the third contact part and the fourth contact part are conductively connected via at least one first switch or a button, or a combination thereof.

6. The switching device of claim 2, wherein the third contact part is conductively connected to the grounding terminal via a second switch, and the fourth contact part is conductively connected to the grounding terminal via a third switch.

7. The switching device of claim 6, wherein the third contact part and the fourth contact part are conductively connected via at least one first switch or a button, and wherein the at least one first switch or button, the second switch and third switch are configured for actuation independent of the switch position of the first and second movable switch contacts.

8. The switching device of claim 1, wherein the first and the second movable switch contacts are mechanically coupled with one another.

9. The switching device of claim 8, wherein the first and the second movable switch contacts are mechanically coupled via a common switch shaft.

10. The switching device of claim 1, further comprising a housing, wherein the first, second, third and fourth contact parts are secured against displacement in the housing.

11. The switching device of claim 1, implemented as a ground-fault circuit interrupter.

12. The switching device of claim 1, implemented as a line circuit breaker.
